(19) United States
(12) Patent Application Publication
(10) Pub. No.: US 2010/0232145 A1
(43) Pub. Date: Sep. 16, 2010

(54) Portable light with integral-designed light source body

(76) Inventor: Yun-Zhao Liu, Zhongshan City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,143

(22) Filed: Mar. 10, 2009

(51) Int. Cl. F21L 4/00

(52) U.S. Cl. 362/157

(57) ABSTRACT

A portable light with an integral-designed light source body is revealed. A connection member is disposed on an edge of a front end of a main body while a plurality of light source bodies for different conditions corresponding to the main body is provided. The light source body includes a connection base with a connection member corresponding to the connection member of the main body. A light source is disposed in the connection base and is connected with a conductive part. A lamp shield is covered on the connection base while a reflector corresponding to the light source is also arranged thereon. Thereby, the main body and the light source body are assembled and located with each other by the connection members. The light source body can be changed according to users' needs. Thus the practicality and convenience of the light are improved due to diversity in applications.

### BACKGROUND OF THE INVENTION

1. Field of the Invention

The present invention relates to a portable light with an integral-designed light source body, especially to a portable light with replaceable light source body whose light source body can be changed according to users' needs. Moreover, the practicality of the portable light is improved due to diversity of the light source body in applications.

2. Description of Related Art

The common light for illumination available now includes a main body, a lamp shield seat and a bottom cover. A lighting part is arranged in a top of the main body and batteries are used as main power source of the lighting part. A switch member that controls the lighting part is used to turn on or off the light. By fastening of the bottom cover with the main body, the batteries are located inside the main body while the lamp shield seat covers the lighting part and locks with the top of the main body. Thus an illumination light is formed.

Although the light composed of a main body and a lamp shield seat emits light to provide people with sufficient illumination, in practice it is unable to be applied in various occasions due to single illumination function. Thus there are restrictions on the applications of the device and there is a space for improvement.

### SUMMARY OF THE INVENTION

Therefore it is a primary object of the present invention to provide a portable light with an integral-designed light source body possesses more practical values.

In order to achieve object, a portable light with an integral-designed light source body of the present invention includes a connection member disposed on an edge of a front end of a main body while a plurality of light source bodies for different conditions corresponding to the main body is provided. The light source body consists of a connection base arranged with a connection member corresponding to the connection member of the main body. A light source is set in the connection base and is connected with a conductive part. A lamp shield is covered over the connection base while a reflector corresponding to the light source is also arranged on there. Thereby, the main body and the light source body are assembled and located with each other by the connection members in usage. The light source body can be changed for various needs or occasions. Thus the practicality and convenience of the portable light are improved due to diversity in applications.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a partial cross sectional view of an embodiment according to the present invention;

FIG. 2 is a cross sectional view of the embodiment in FIG. 1 according to the present invention;

FIG. 3 is a perspective view of the embodiment in FIG. 1 according to the present invention;

FIG. 4 is a cross sectional view of another embodiment according to the present invention;

FIG. 5 is a perspective view of the embodiment in FIG. 4 according to the present invention;

FIG. 6 is a cross sectional view of a further embodiment according to the present invention;

FIG. 7 is a perspective view of the embodiment in FIG. 6 according to the present invention;

FIG. 8 is a cross sectional view of a further embodiment according to the present invention;

FIG. 9 is a perspective view of the embodiment in FIG. 8 according to the present invention.

### DETAILED DESCRIPTION OF THE PREFERRED EMBODIMENT

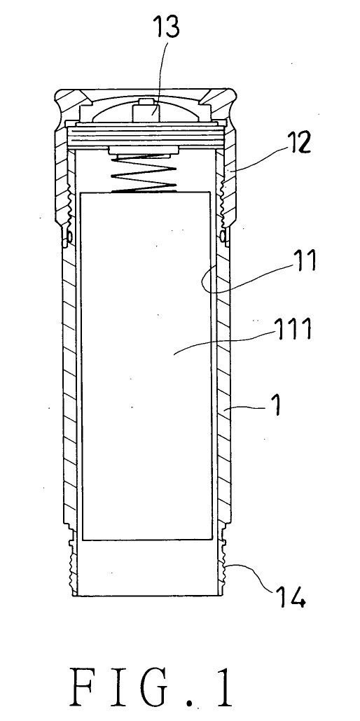

Referring to FIG. 1, a partial cross sectional view of a main body of an embodiment is revealed. The embodiment of the present invention includes a main body (1) and a battery compartment (11) that holds batteries disposed inside the main body (1). A rear cover (12) is arranged on a rear end of the main body (1) and a switch member (13) is disposed on the rear cover (12). A connection member (14) is disposed on an edge of a front end of the main body (1) and the connection member (14) is a threaded section.

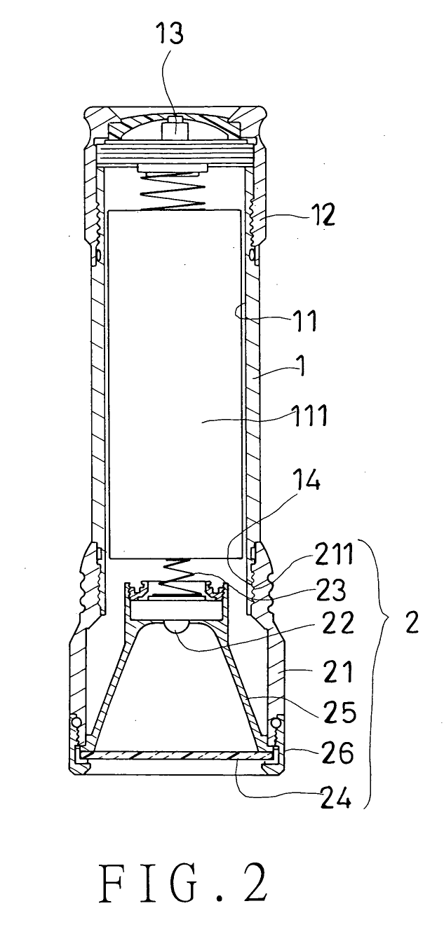

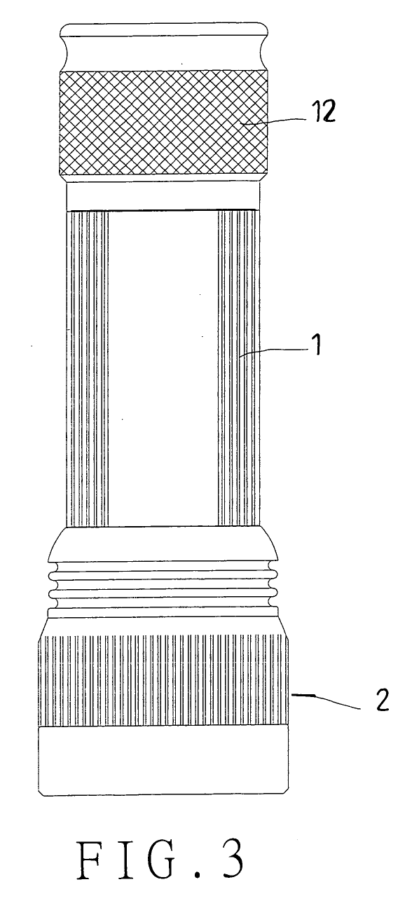

Referring to FIGS. 2 and 3, the connection member (14) of the main body (1) is to connect with a light source body (2). The light source body (2) consists of a connection base (21) with a connection member (211) corresponding to the connection member (14) of the main body (1). When the connection member (14) of the main body (1) is a threaded section, the connection member (211) of the connection base (21) is also a threaded section. A light source (22) is disposed in the connection base (21) and is connected with a conductive part (23). A lamp shield (24) is covered on the connection base (21). A reflector (25) corresponding to the light source (22) is also arranged on the light source (22). By a front cover (26), the lamp shield (24) is located on the connection base (21).

Accordingly, while in use, the light source body (2) can be changed according to users' requirements. A battery (111) is loaded into the battery compartment (11) inside the main body (1). And then assemble the main body (1) with the light source body (2) and connect them by the connection members (14) and (211). Thus users can press the switch member (13) of the main body (1) so as to make the battery (111) provide power to the light source (22) of the light source body (2). Light emitted from the light source (22) is reflected by the reflector (25) that corresponds to the light source (22) and is projected through the lamp shield (24).

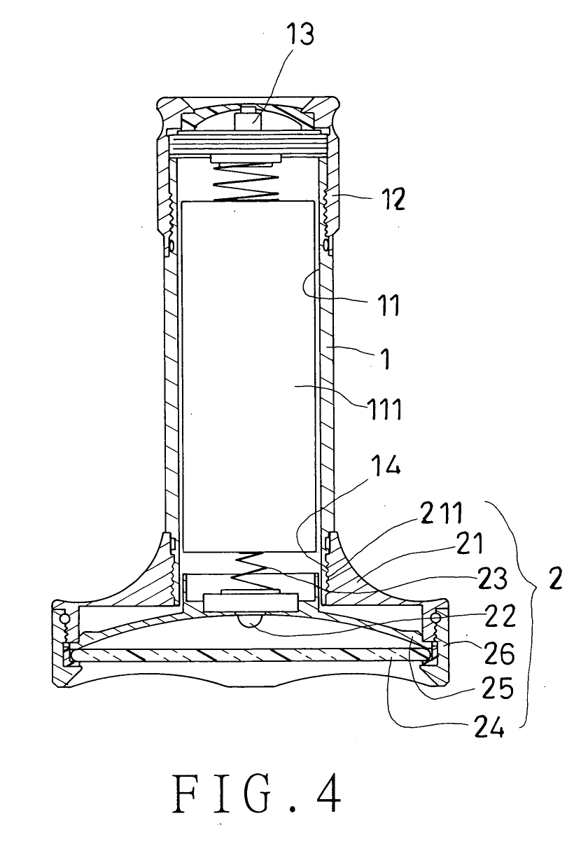

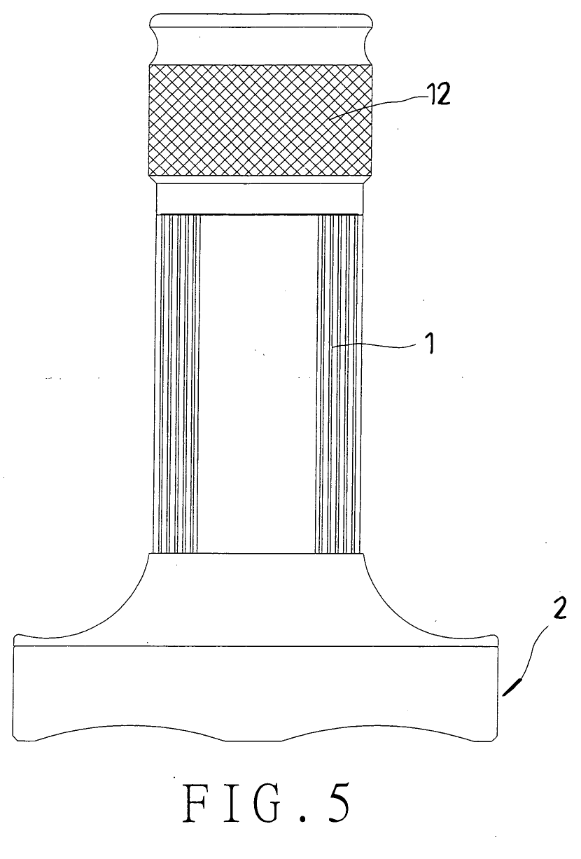

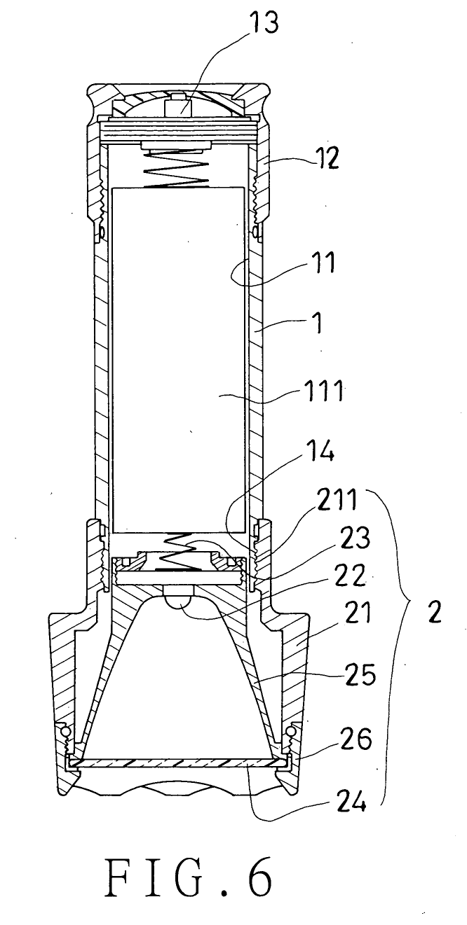

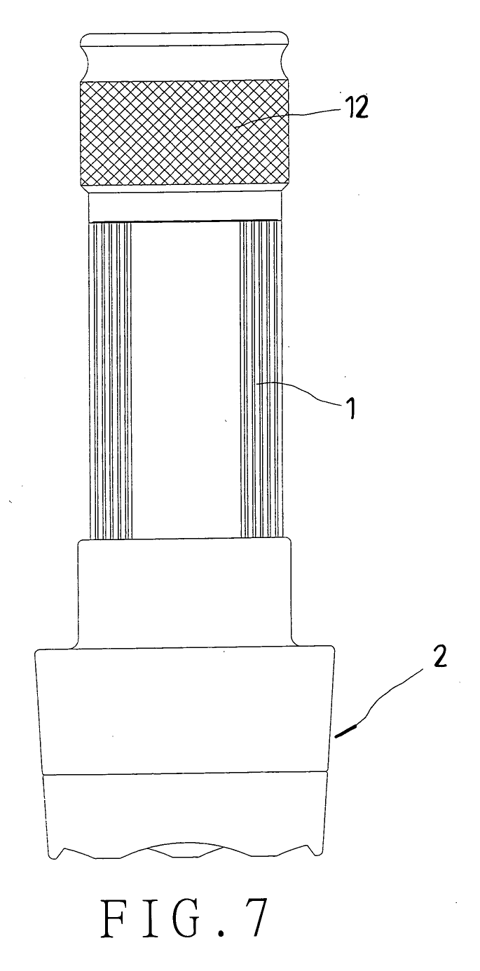

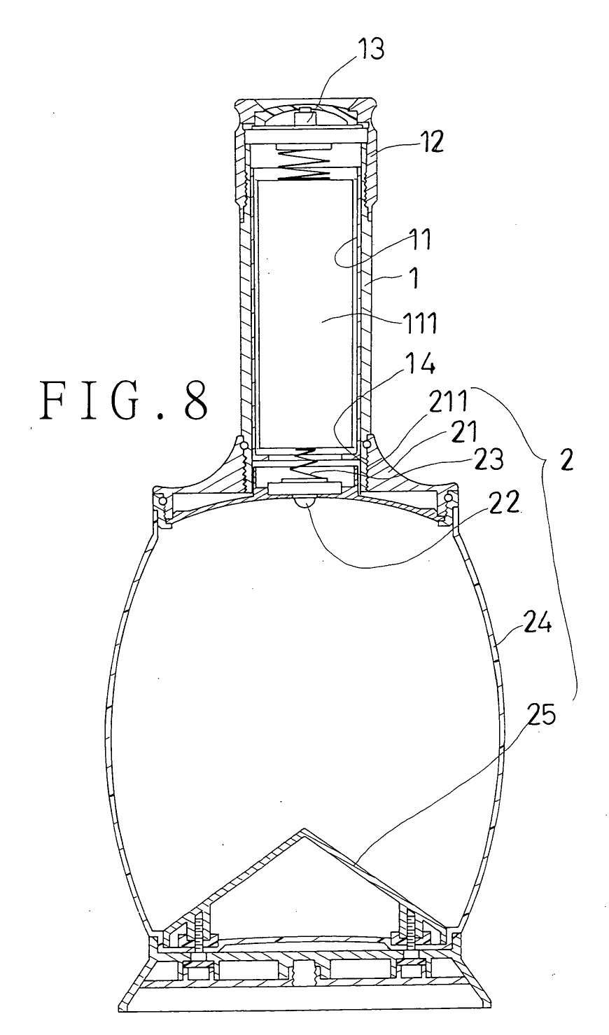

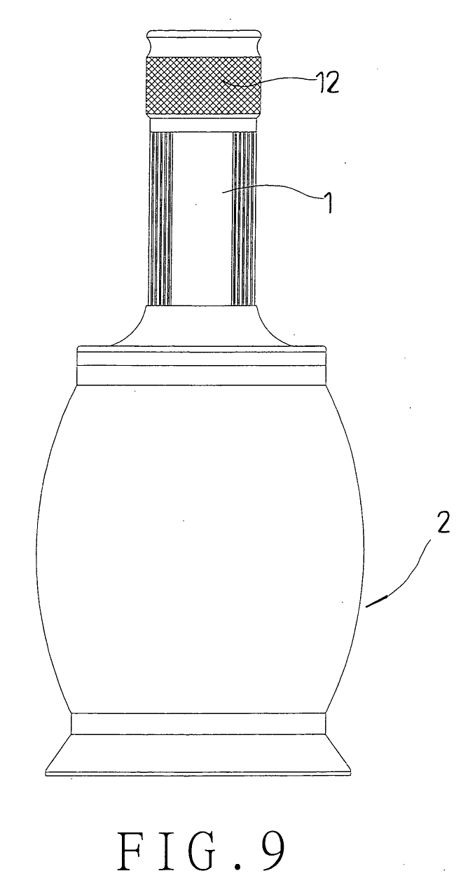

The light source body (2) can be replaced by users if they need. For example, the light source body (2) can be for general illumination, as the embodiment shown in FIGS. 2 and 3. Or refer to another embodiment shown in FIGS. 4 and 5, the light source body (2) has a large area. And the reflector (25) in the light source body (2) is a concave curved surface with large area. Thus light from the light source (22) emits after reflected by the reflector (25) in large area so as to achieve large area illumination. Refer to FIGS. 6 and 7, a cross sectional view and a perspective view of a further embodiment are disclosed. The edge on the front end of the light source body (2) is disposed with a wave-like projecting part. Thus the device can not only be used for lighting, but also work as outdoor survival/rescue equipment. The wave-like projecting part on the front end of the light source body (2) is used to dig things or break fragile objects such as glass etc. When a car falls into water, it is difficult for passengers in the car to escape through the door due to the water pressure. People can use the projecting part on the front end of the light source body (2) to break the window out and escape. Referring to FIGS. 8 and 9, a cross sectional view and a perspective view of a further embodiment are disclosed. The connection base (21) is covered by a hollow lamp shield (24) filled with air therein. Thus the device is not only used as a lighting device but is also put into water as a fishing light. Due to air filled inside the lamp shield (24), the device floats on water and light emitted therefrom attracts fish. Thus the device is used as a fishing light for anglers to attract fish, providing illumination while fishing, or working as a distress light for people floating in the water.

In summary, compared with lights available now, the portable light of the present invention includes a connection member is disposed on the edge of the front end of a main body while a plurality of light source bodies for different conditions corresponding to the main body is provided. The light source body includes a connection member corresponding to the connection member of the main body disposed on the connection base. In use, the main body and the light source body are assembled and located with each other by the connection members and the light source body can be changed according to users' needs or occasions. Therefore, the practicality and convenience of the portable light are improved due to diversity in applications.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A portable light with an integral-designed light source body comprising a main body and a plurality of light source bodies corresponding to the main body,
wherein a connection member is disposed on an edge of a front end of the main body and is assembled with the light source body correspondingly according to needs or occasions,
the light source body having a connection base disposed with a connection member corresponding to the connection member of the main body, a light source disposed in the connection base and connected with a conductive part, a lamp shield covered over the connection base and a reflector corresponding to the light source arranged in the connection base.

2. The device as claimed in claim 1, wherein the connection member of the main body and the connection member and the connection member disposed on the connection base of the light source body are threaded sections corresponding to each other.

3. The device as claimed in claim 1, wherein a front cover is disposed over the connection base for locating the lamp shield on the connection base.

4. The device as claimed in claim 1, wherein the light source body is for general illumination.

5. The device as claimed in claim 1, wherein the reflector in the light source body is a concave curved surface with large area so as to reflect light emitted from the light source and large area illumination is achieved.

6. The device as claimed in claim 1, wherein a wave-like projecting part is disposed on an edge on a front end of the light source body and the projecting part is used to dig things, break fragile objects, and work as a survival and rescue equipment.

7. The device as claimed in claim 1, wherein the connection base of the light source body is covered by a hollow lamp shield that is filled with air therein to float on water so that the portable light is used as a fishing light for anglers to attract fish, providing illumination while fishing, and working as a distress light for people in the water.
